(19) United States
(12) Patent Application Publication
(10) Pub. No.: US 2016/0352188 A1
(43) Pub. Date: Dec. 1, 2016

(54) INTEGRATED CIRCUIT, DRIVING CIRCUIT FOR MOTOR, MOTOR ASSEMBLY AND APPLICATION EQUIPMENT THEREFOR

(71) Applicant: Johnson Electric S.A., Murten (CH)

(72) Inventors: Chi Ping SUN, Hong Kong (CN); Shing Hin YEUNG, Hong Kong (CN); Fei XIN, Shen Zhen (CN); Xiu Wen YANG, Shen Zhen (CN); Shu Juan HUANG, Shen Zhen (CN); Yun Long JIANG, Shen Zhen (CN); Yue LI, Hong Kong (CN); Bao Ting LIU, Shen Zhen (CN); En Hui WANG, Shen Zhen (CN); Li Sheng LIU, Shen Zhen (CN); Yan Yun CUI, Shen Zhen (CN)

(21) Appl. No.: 15/231,249

(22) Filed: Aug. 8, 2016

Related U.S. Application Data
(63) Continuation-in-part of application No. 14/822,353, filed on Aug. 10, 2015.
Application No. 14/822,353 is a continuation of application No. PCT/CN2015/086422, filed on Aug. 7, 2015.

(30) Foreign Application Priority Data
Aug. 8, 2014 (CN) 201410390592.2
Aug. 15, 2014 (CN) 201410404474.2
Jul. 5, 2016 (CN) 201610523521.4

(51) Int. Cl. H02K 11/04; H02K 1/27; H02P 6/26; H02K 11/215; H02K 21/12; H02P 6/16

(52) U.S. Cl. CPC H02K 11/04; H02K 21/12; H02P 6/16; H02P 6/26; H02K 11/215; H02K 1/2706

(57) ABSTRACT

An integrated circuit includes a housing, a semiconductor substrate arranged in the housing, several pins extended out from the housing, and an electronic circuitry having a rectifier arranged on the semiconductor substrate. The rectifier includes a controllable switch.

### CROSS REFERENCE TO RELATED APPLICATIONS

This application is a continuation-in-part of co-pending U.S. patent application Ser. No. 14/822,353, filed on Aug. 10, 2015, which claims priority under 35 U.S.C. §119(a) from Patent Application No. 201410390592.2 filed in the People's Republic of China on Aug. 8, 2014, and Patent Application No. 201410404474.2 filed in the People's Republic of China on Aug. 15, 2014. In addition, this application claims priority under 35 U.S.C. §119(a) from Patent Application No. PCTCN2015086422 as PCT application filed in Receiving Office of CN on Aug. 7, 2015, to Chinese Patent Application No. CN201610523521.4, filed with the Chinese Patent Office on Jul. 5, 2016, all of which are expressly incorporated herein by reference in their entireties and for all purposes.

### FIELD

The disclosure relates to a driving circuit for a motor, and in particular to an integrated circuit applied to a driving circuit for a motor, a motor assembly, and an application equipment using the driving circuit.

### BACKGROUND

In a starting process of a synchronous motor, an electromagnet of a stator generates an alternating magnetic field, which is equivalent to a resultant magnetic field of a forward rotating magnetic field and a backward rotating magnetic field. And the alternating magnetic field drags a permanent magnetic rotor to be oscillated with a deflection. Finally the rotation of the rotor in a direction is accelerated rapidly to be synchronized with the alternating magnetic field of the stator if deflection oscillation amplitude of the rotor is increased. Generally a starting torque of the motor is set to be large to ensure the synchronous motor capable of starting, and thus the motor operates at a working point with a low efficiency. In addition, the rotor cannot be ensured to the rotor start to rotate in a same direction each time since a stop position of the permanent magnetic rotor and a polarity of an alternating current (AC) in initial energizing are unfixed. Accordingly, a fan and a pump having a motor work in a low operational efficiency.

### BRIEF DESCRIPTION OF THE DRAWINGS

FIG. 1 shows a single-phase permanent magnetic synchronous motor according to an embodiment of the present disclosure;

FIG. 2 shows a schematic circuit diagram of a single-phase permanent magnetic synchronous motor according to an embodiment of the present disclosure;

FIG. 3 shows a circuit block diagram of an implementing way of the integrated circuit shown in FIG. 2;

FIG. 4 shows a circuit block diagram of an implementing way of the integrated circuit shown in FIG. 2;

FIG. 5 shows a circuit of the motor shown in FIG. 2 according to an embodiment;

FIG. 6 shows a waveform of the circuit of the motor shown in FIG. 5;

FIGS. 7, 8, 9, 9A, and 9B show the circuit of the motor shown in FIG. 2 according to other embodiments;

FIG. 10 shows a schematic circuit diagram of a single-phase permanent magnetic synchronous motor according to an embodiment of the present disclosure;

FIG. 11 shows a circuit block diagram of an implementing way of the integrated circuit shown in FIG. 10;

FIG. 12 shows a schematic circuit diagram of a single-phase permanent magnetic synchronous motor according to an embodiment of the present disclosure;

FIG. 13 shows a water pump including the above-described motor; and

FIG. 14 shows a fan using including the above-described motor.

### DETAILED DESCRIPTION OF THE EMBODIMENTS

Hereinafter, particular embodiments of the present disclosure are described in detail in conjunction with the drawings, so that technical solutions and other beneficial effects of the present disclosure are apparent. It can be understood that the drawings are provided only for reference and explanation, and are not used to limit the present disclosure. Dimensions shown in the drawings are only for ease of clear description, but are not limited to a proportional relationship.

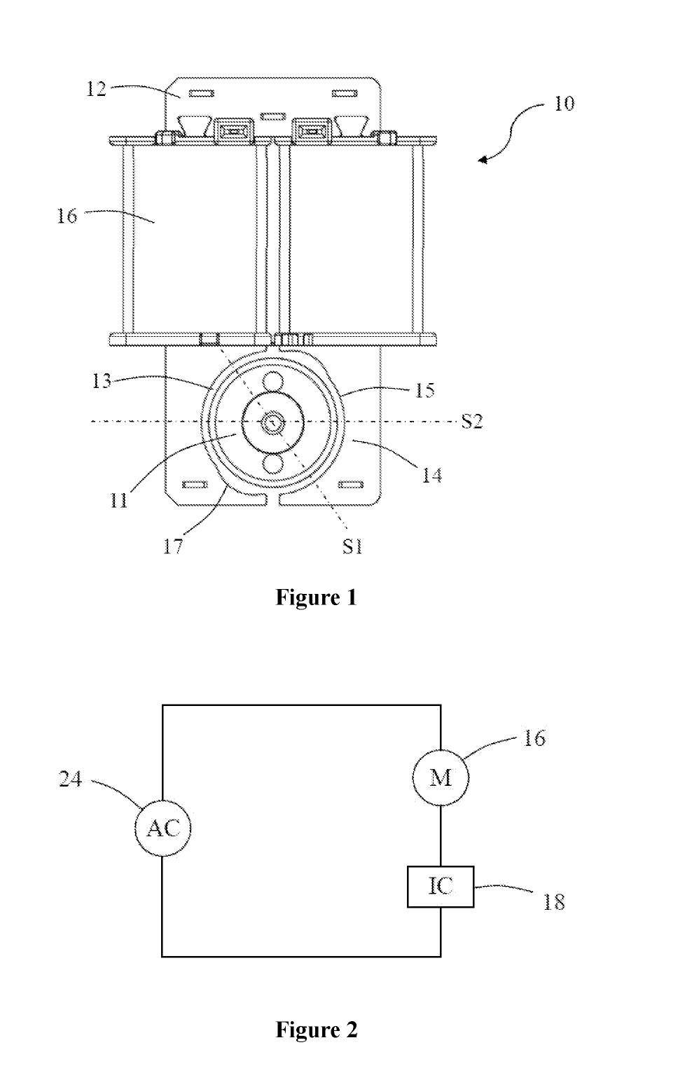

FIG. 1 shows a single-phase permanent magnetic synchronous motor according to an embodiment of the present disclosure. The synchronous motor 10 includes a stator and a rotor 11 rotatable relative to the stator. The stator includes a stator core 12 and a stator winding 16 wound on the stator core 12. The stator core may be made of soft magnetic materials such as pure iron, cast iron, cast steel, electrical steel, silicon steel. The rotor 11 includes a permanent magnet, the rotor 11 operates at a constant rotational speed of 60 f/p rpm during a steady state phase in a case that the stator winding 16 is connected with an AC power supply in series, where f is a frequency of the AC power supply and p is the number of pole pairs of the rotor. In the embodiment, the stator core 12 includes two poles 14 opposite to each other. Each pole 14 includes a pole arc 15, an outside surface of the rotor 11 is opposite to the pole arc 15, and a substantially uniform air gap 13 is formed between the outside surface of the rotor 11 and the pole arc 15. The “substantially uniform air gap” according to the present disclosure means that a uniform air gap is formed in most space between the stator and the rotor, and a non-uniformed air gap is formed in a small part of the space between the stator and the rotor. Preferably, a starting groove 17 which is concave may be disposed in the pole arc 15 of the pole of the stator, and a part of the pole arc 15 rather than the starting groove 17 may be concentric with the rotor. With the configuration described above, the non-uniform magnetic field may be formed, a polar axis S1 of the rotor has an angle of inclination relative to a central axis S2 of the pole 14 of the stator in a case that the rotor is at rest (as shown in FIG. 1), and the rotor may have a starting torque every time the motor is powered on under the action of the driving circuit. Specifically, the “pole axis S1 of the rotor” refers to a boundary between two magnetic poles having different polarities, and the “central axis S2 of the pole 14 of the stator” refers to a connection line passing central points of the two poles 14 of the stator. In the embodiment, both the stator and the rotor include two magnetic poles. It can be understood that the number of magnetic poles of the stator may not be equal to the number of magnetic poles of the rotor, and the stator and the rotor may have more magnetic poles, such as 4 or 6 magnetic poles in other embodiments.

FIG. 2 shows a schematic circuit diagram of a single-phase permanent magnetic synchronous motor 10 according to an embodiment of the present disclosure. The stator winding 16 of the motor and the integrated circuit 18 are connected in series between two terminals of the AC power supply 24. The driving circuit for the motor is integrated into the integrated circuit 18, and the driving circuit enables the motor to start in a fixed direction every time the motor is powered on.

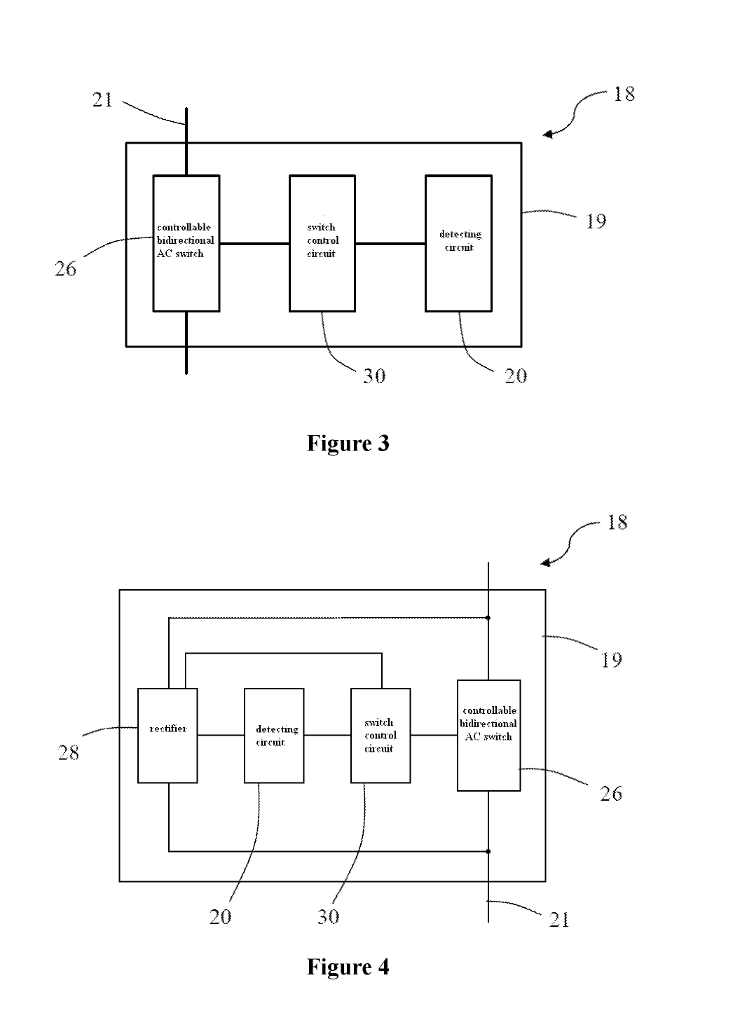

FIG. 3 shows an implementing way of the integrated circuit 18. The integrated circuit includes a housing 19, two pins 21 extended out from the housing 19, and a driving circuit packaged in the housing 19. The driving circuit is disposed on a semiconductor substrate, and the driving circuit includes a detecting circuit 20 configured to detect a magnetic field polarity of a rotor of the motor, a controllable bidirectional AC switch 26 connected between the two pins 21, and a switch control circuit 30 configured to control the controllable bidirectional AC switch 26 to be switched between a switch-on state and a switch-off state in a preset way, based on the magnetic field polarity of the rotor detected by the detecting circuit 20.

Preferably, the switch control circuit 30 is configured to switch on the controllable bidirectional AC switch 26 in a case that the AC power supply 24 is in a positive half cycle and the magnetic field polarity of the rotor is a first polarity, or in a case that the AC power supply 24 is in a negative half cycle and the magnetic field polarity of the rotor is a second polarity opposite to the first polarity. The configuration enables the stator winding 16 to drag the rotor only in a fixed direction in a starting phase of the motor.

FIG. 4 shows an implementing way of the integrated circuit 18. FIG. 4 differs from FIG. 3 in that, the integrated circuit shown in FIG. 4 further includes a rectifier 28, which is connected in parallel with the controllable bidirectional AC switch 26 between the two pins 21, and may generate a DC supplied for the detecting circuit 20. In the embodiment, preferably, the detecting circuit 20 may be a magnetic sensor (may also be referred as a position sensor), and the integrated circuit is installed near the rotor so that the magnetic sensor can sense a magnetic field variation of the rotor. It can be understood that the detecting circuit 20 may not include a magnetic sensor, and the magnetic field variation of the rotor may be detected in other ways in other embodiments. In the embodiment according to the present disclosure, the driving circuit for the motor is packaged in the integrated circuit, and thus the cost of the circuit can be reduced, and the reliability of the circuit can be improved. In addition, the motor may not include a PCB, and it just needs to fix the integrated circuit in a proper position and connect the integrated circuit to a line group and a power supply of the motor via leading wires.

In the embodiment according to the present disclosure, the stator winding 16 and the AC power supply 24 are connected in series between two nodes A and B. Preferably, the AC power supply 24 may be a mains AC power supply with a fixed frequency such as 50 Hz or 60 Hz, and a supply voltage may be, for example, 110V, 220V or 230V. The controllable bidirectional AC switch 26, and the stator winding 16 and the AC power supply 24 connected in series, are connected in parallel between the two nodes A and B. Preferably, the controllable bidirectional AC switch 26 may be a TRIAC, of which two anodes are connected to the two pins 21 respectively. It can be understood that the controllable bidirectional AC switch 26 may include two unidirectional thyristors reversely connected in parallel, and the respective control circuit may be disposed to control the two unidirectional thyristors in a preset way. The rectifier 28 and the controllable bidirectional AC switch 26 are connected in parallel between the two pins 21. An AC between the two pins 21 is converted by the rectifier 28 into a low voltage DC. The detecting circuit 20 may be powered by the low voltage DC output by the rectifier 28, and be configured to detect the magnetic pole position of the permanent magnetic rotor 11 of the synchronous motor 10 and output a respective signal.

A switch control circuit 30 is connected to the rectifier 28, the detecting circuit 20 and the controllable bidirectional AC switch 26, and is configured to control the controllable bidirectional AC switch 26 to be switched between a switch-on state and a switch-off state in a preset way, based on information on the magnetic pole position of the permanent magnetic rotor detected by the detecting circuit 20 and the polarity of the AC power supply 24, such that the stator winding 16 drags the rotor 14 to rotate only in the above-mentioned fixed starting direction in the starting phase of the motor. According to the present disclosure, in a case that the controllable bidirectional AC switch 26 is switched on, the two pins 21 are shorted, and the rectifier 28 does not consume electric energy since there is no current flowing through the rectifier 28, hence, the utilization efficiency of electric energy can be improved significantly.

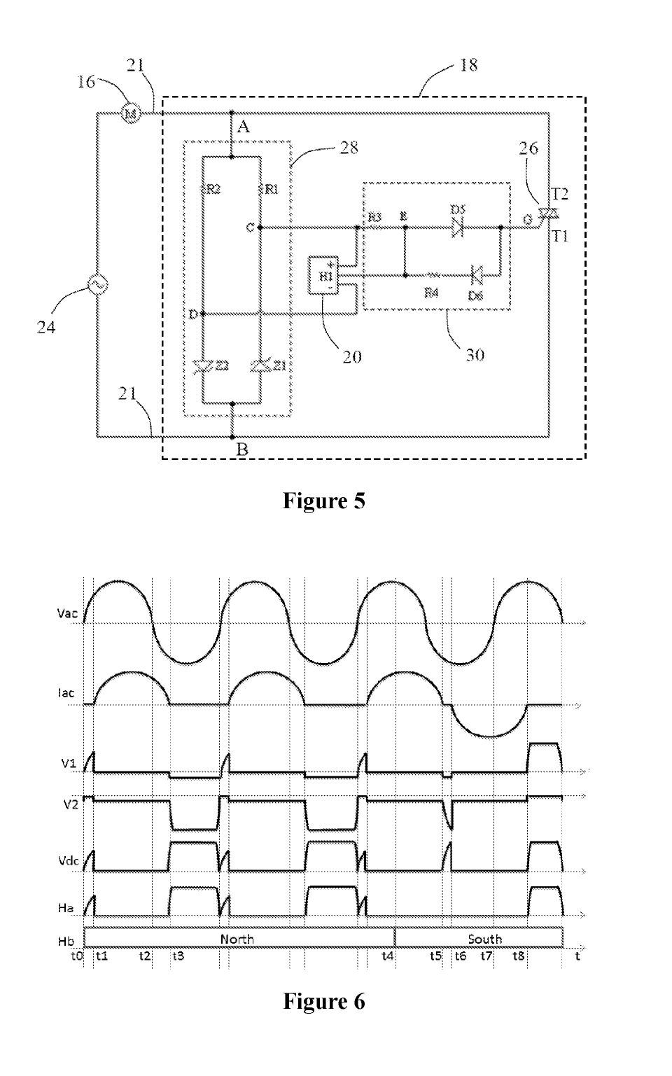

FIG. 5 shows a circuit of the motor shown in FIG. 2 according to an embodiment. The stator winding 16 of the motor is connected in series with the AC power supply 24 between the two pins 21 of the integrated circuit 18. Two nodes A and B are connected to the two pins 21 respectively. A first anode T2 of the TRIAC 26 is connected to the node A, and a second anode T1 of the TRIAC 26 is connected to the node B. The rectifier 28 is connected in parallel with the TRIAC 26 between the two nodes A and B. An AC voltage between the two nodes A and B is converted by the rectifier 28 into a low DC voltage (preferably, the low voltage is in a range from 3V to 18V). The rectifier 28 includes a first resistor R1, second resistor R2 and a first zener diode Z1 and a second zener diode Z2 which are reversely connected in parallel between the two nodes A and B. A high voltage output terminal C of the rectifier 28 is formed at a connection point of the first resistor R1 and a cathode of the first zener diode Z1, and a low voltage output terminal D of the rectifier 28 is formed at a connection point of the second resistor R2 and an anode of the second zener diode Z2. The voltage output terminal C is connected to a positive power supply terminal of the position sensor 20, and the voltage output terminal D is connected to a negative power supply terminal of the position sensor 20. Three terminals of the switch control circuit 30 are connected to the high voltage output terminal C of the rectifier 28, an output terminal H1 of the position sensor 20 and a control electrode G of the TRIAC 26 respectively. The switch control circuit 30 includes a third resistor R3, a fifth diode D5, and a fourth resistor R4 and a sixth diode D6 connected in series between the output terminal H1 of the position sensor 20 and the control electrode G of the controllable bidirectional AC switch 26. An anode of the sixth diode D6 is connected to the control electrode G of the controllable bidirectional AC switch 26. One terminal of the third resistor R3 is connected to the high voltage output terminal C of the rectifier 28, and the other terminal of the third resistor R3 is connected to an anode of the fifth diode D5. A cathode of the fifth diode D5 is connected to the control electrode G of the controllable bidirectional AC switch 26.

In reference with FIG. 6, an operational principle of the above-mentioned circuit is described. In FIG. 6, Vac indicates a waveform of a voltage of the AC power supply 24, and Iac indicates a waveform of a current flowing through the stator winding 16. Due to the inductive character of the stator winding 16, the waveform of the current Iac lags behind the waveform of the voltage Vac. V1 indicates a waveform of a voltage between two terminals of the zener diode Z1, V2 indicates a waveform of a voltage between two terminals of the zener diode Z2, Vcd indicates a waveform of a voltage between two output terminals C and D of the rectifier 28, Ha indicates a waveform of a signal output from the output terminal H1 of the position sensor 20, and Hb indicates a rotor magnetic field detected by the position sensor 20. In this embodiment, in a case that the position sensor 20 is powered normally, the output terminal H1 outputs a logic high level in a case that the detected rotor magnetic field is North, or the output terminal H1 outputs a logic low level in a case that the detected rotor magnetic field is South.

In a case that the rotor magnetic field Hb detected by the position sensor 20 is North, in a first positive half cycle of the AC power supply, a supply voltage is gradually increased in a period of time from a time instant t0 to a time instant t1, the output terminal H1 of the position sensor 20 outputs a high level, and a current flows through the resistor R1, the resistor R3, the diode D5 and the control electrode G and the second anode T1 of the TRIAC 26 sequentially. The TRIAC 26 is switched on in a case that a driving current flowing through the control electrode G and the second anode T1 is greater than a gate triggering current Ig. Once the TRIAC 26 is switched on, the two nodes A and B are shorted, a current flowing through the stator winding 16 in the motor is gradually increased until a large forward current flows through the stator winding 16, and the rotor 14 is driven to rotate clockwise as shown in FIG. 3. Since the two nodes A and B are shorted, there is no current flowing through the rectifier 28 in a period of time from the time instant t1 to a time instant t2. Hence, the resistors R1 and R2 do not consume electric energy, and the output of the position sensor 20 is stopped due to no power supply voltage. Since there is a sufficient large current flowing through two anodes T1 and T2 of the TRIAC 26 (which is greater than a holding current Ihold), the TRIAC 26 is kept to be switched on in a case that there is no driving current flowing through the control electrode G and the second anode T1. In a negative half cycle of the AC power supply, after a time instant t3, a current flowing through T1 and T2 is less than the holding current I_{hold}, the TRIAC 26 is switched off, a current begins to flow through the rectifier 28, and the output terminal H1 of the position sensor 20 outputs a high level again. Since a potential at a point C is lower than a potential at a point E, there is no driving current flowing through the control electrode G and the second anode T1 of the TRIAC 26, and the TRIAC 26 is kept to be switched off. Since the resistances of the resistors R1 and R2 in the rectifier 28 are far greater than the resistance of the stator winding 16 in the motor, a current currently flowing through the stator winding 16 is far less than the current flowing through the stator winding 16 in a period of time from the time instant t1 to the time instant t2, and there is no driving force for the rotor 14. Hence, the rotor 14 continues to rotate clockwise due to the inertia effect. In a second positive half cycle of the AC power supply, similar to the first positive half cycle, a current flows through the resistor R1, the resistor R3, the diode D5, and the control electrode G and the second anode T1 of the TRIAC 26 sequentially. The TRIAC 26 is switched on again, the current flowing through the stator winding 16 continues to drive the rotor 14 to rotate clockwise. Similarly, the resistors R1 and R2 do not consume electric energy since the two nodes A and B are shorted; in the negative half cycle of the power supply, the current flowing through the two anodes T1 and T2 of the TRIAC 26 is less than the holding current I_{hold}, the TRIAC 26 is switched off again, and the rotor continues to rotate clockwise due to the inertia effect.

At a time instant t4, the rotor magnetic field Hb detected by the position sensor 20 changes to be South from North, the AC power supply is in the positive half cycle and the TRIAC 26 is switched on, the two nodes A and B are shorted, and there is no current flowing through the rectifier 28. After the AC power supply is in the negative half cycle, the current flowing through the two anodes T1 and T2 of the TRIAC 26 is gradually decreased, and the TRIAC 26 is switched off at a time instant t5. Then the current flows through the second anode Ti and the control electrode G of the TRIAC 26, the diode D6, the resistor R4, the position sensor 20, the resistor R2 and the stator winding 16 sequentially. As the driving current is gradually increased, the TRIAC 26 is switched on again at a time instant t6, the two nodes A and B are shorted again, the resistors R1 and R2 do not consume electric energy, and the output of the position sensor 20 is stopped due to no power supply voltage. There is a large reverse current flowing through the stator winding 16, and the rotor 14 continues to be driven clockwise since the rotor magnetic field is South. In a period of time from the time instant t5 to the time instant t6, the first zener diode Z1 and the second zener diode Z2 are switched on, hence, there is a voltage output between the two output terminals C and D of the rectifier 28. At a time instant t7, the AC power supply is in the positive half cycle again, the TRIAC 26 is switched off once the current flowing through the TRIAC 26 crosses zero, and then a voltage of the control circuit is gradually increased. As the voltage is gradually increased, a current begins to flow through the rectifier 28, the output terminal H1 of the position sensor 20 outputs a low level, there is no driving current flowing through the control electrode G and the second anode T1 of the TRIAC 26, hence, the TRIAC 26 is switched off. Since the current flowing through the stator winding 16 is small, no driving force is generated for the rotor 14. At a time instant t8, the power supply is in the positive half cycle, the position sensor outputs a low level, the TRIAC 26 is kept to be switched off after the current crosses zero, and the rotor continues to rotate clockwise due to the inertia effect. According to the present disclosure, the rotor may be accelerated to be synchronized with the field of the stator by rotating only one circle after the stator winding is powered on.

With the circuit according to the embodiment of the present disclosure, the motor can be ensured to start and rotate in a same direction every time the motor is powered on. In applications such a fan and a water pump, a flabellum and an impeller driven by the rotor may have curved vanes, and thus the efficiency of the fan and the water pump is improved. In addition, in the embodiment of the present disclosure, by taking advantage of a characteristic of the TRIAC that the TRIAC is kept to be switched on although there is no driving current flowing though the TRIAC once the TRIAC is switched on, it is avoided that the resistor R1 and the resistor R2 in the rectifier 28 still consumes electric energy after the TRIAC is switched on, hence, the utilization efficiency of electric energy can be improved significantly.

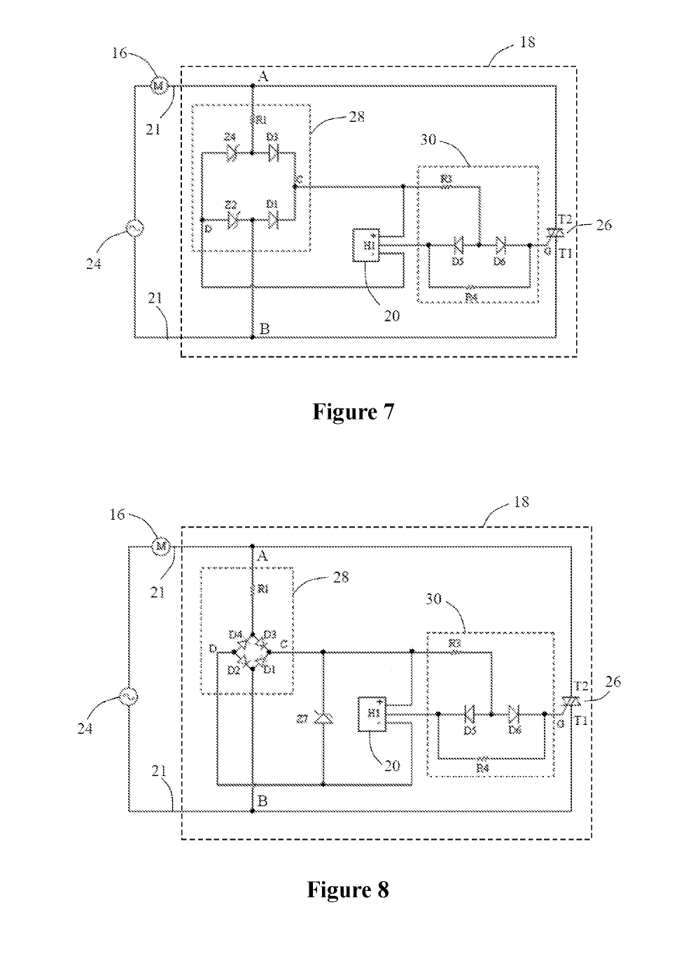

FIG. 7 shows the circuit of the motor shown in FIG. 2 according to an embodiment. The stator winding 16 of the motor is connected in series with the AC power supply 24 between the two pins 21 of the integrated circuit 18. The two nodes A and B are connected to the two pins 21 respectively. A first anode T2 of the TRIAC 26 is connected to the node A, and a second anode T1 of the TRIAC 26 is connected to the node B. The rectifier 28 is connected in parallel with the TRIAC 26 between the two nodes A and B. An AC between the two nodes A and B is converted by the rectifier 28 into a low voltage DC, preferably, the low voltage is in a range from 3V to 18V. The rectifier 28 includes a first resistor R1 and a full wave bridge rectifier connected in series between the two nodes A and B. The first resistor R1 may be used as a voltage dropper, and the full wave bridge rectifier includes two rectifier branches connected in parallel, one of the two rectifier branches includes a first diode D1 and a third diode D3 reversely connected in series, and the other of the two rectifier branches includes a second zener diode Z2 and a fourth zener diode Z4 reversely connected in series, the high voltage output terminal C of the rectifier 28 is formed at a connection point of a cathode of the first diode D1 and a cathode of the third diode D3, and the low voltage output terminal D of the rectifier 28 is formed at a connection point of an anode of the second zener diode Z2 and an anode of the fourth zener diode Z4. The output terminal C is connected to a positive power supply terminal of the position sensor 20, and the output terminal D is connected to a negative power supply terminal of the position sensor 20. The switch control circuit 30 includes a third resistor R3, a fourth resistor R4, and a fifth diode D5 and a sixth diode D6 reversely connected in series between the output terminal H1 of the position sensor 20 and the control electrode G of the controllable bidirectional AC switch 26. A cathode of the fifth diode D5 is connected to the output terminal H1 of the position sensor, and a cathode of the sixth diode D6 is connected to the control electrode G of the controllable bidirectional AC switch. One terminal of the third resistor R3 is connected to the high voltage output terminal C of the rectifier, and the other terminal of the third resistor R3 is connected to a connection point of an anode of the fifth diode D5 and an anode of the sixth diode D6. Two terminals of the fourth resistor R4 are connected to a cathode of the fifth diode D5 and a cathode of the sixth diode D6 respectively.

FIG. 8 shows the circuit of the motor shown in FIG. 2 according to an embodiment. The embodiment differs from the previous embodiment in that, the zener diodes Z2 and Z4 in FIG. 7 are replaced by general diodes D2 and D4 in the rectifier in FIG. 8. In addition, a zener diode Z7 as a voltage regulator is connected between the two output terminals C and D of the rectifier 28 in FIG. 8.

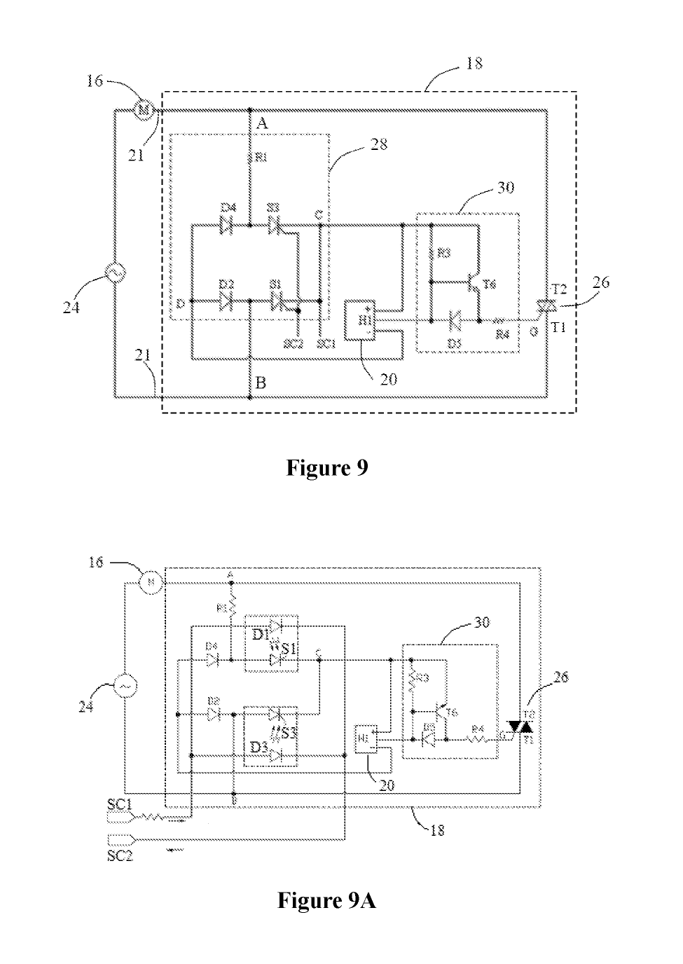

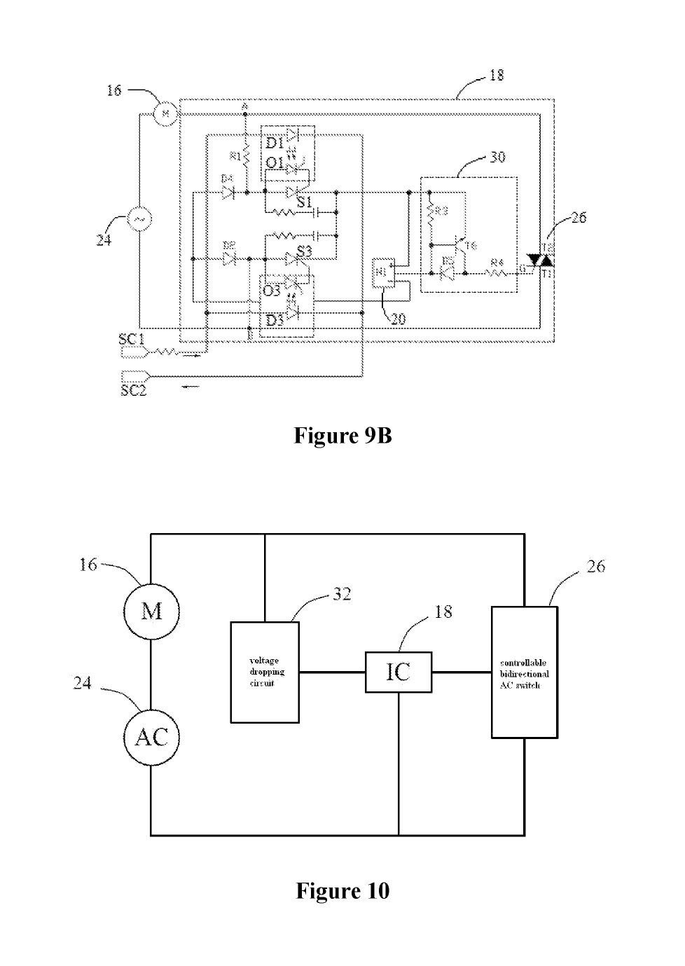

FIG. 9 shows the circuit of the motor shown in FIG. 2 according to an embodiment. The stator winding 16 of the synchronous motor is connected in series with the AC power supply 24 between the two pins 21 of the integrated circuit 18. Two nodes A and B are connected to the two pins 21 respectively. A first anode T2 of the TRIAC 26 is connected to the node A, and a second anode T1 of the TRIAC 26 is connected to the node B. The rectifier 28 is connected in parallel with the TRIAC 26 between the two nodes A and B. An AC between the two nodes A and B is converted by the rectifier 28 into a low voltage DC, preferably, the low voltage is in a range from 3V to 18V. The rectifier 28 includes a first resistor R1 and a full wave bridge rectifier connected in series between the two nodes A and B. The first resistor R1 may be used as a voltage dropper. The full wave bridge rectifier includes two rectifier branches connected in parallel, one of the two rectifier branches includes two unidirectional thyristors S1 and S3 reversely connected in series, and the other of the two rectifier branches includes a second diode D2 and a fourth diode D4 reversely connected in series. The high voltage output terminal C of the rectifier 28 is formed at a connection point of a cathode of the unidirectional thyristor S1 and a cathode of the unidirectional thyristor S3, and the low voltage output terminal D of the rectifier 28 is formed at a connection point of an anode of the second diode D2 and an anode of the fourth diode D4. The output terminal C is connected to a positive power supply terminal of the position sensor 20, and the output terminal D is connected to a negative power supply terminal of the position sensor 20. The switch control circuit 30 includes a third resistor R3, an NPN triode T6, and a fourth resistor R4 and a fifth diode D5 connected in series between the output terminal H1 of the position sensor 20 and the control electrode G of the controllable bidirectional AC switch 26. A cathode of the fifth diode D5 is connected to the output terminal H1 of the position sensor. One terminal of the third resistor R3 is connected to the high voltage output terminal C of the rectifier, and the other terminal of the third resistor R3 is connected to the output terminal H1 of the position sensor. A base of the NPN triode T6 is connected to the output terminal H1 of the position sensor, an emitter of the NPN triode T6 is connected to an anode of the fifth diode D5, and a collector of the NPN triode T6 is connected to the high voltage output terminal C of the rectifier.

In this embodiment, a control signal is inputted into the control terminals of the two switches S1 and S3 via two terminals SC1 and SC2. The S1 and S3 are switched on in a case that a control signal input from the terminal SC2 is a high level, or S1 and S3 are switched off due to no driving current in a case that the control signal input from the terminal SC2 is a low level. Based on the configuration, S1 and S3 may be switched between a switch-on state and a switch-off state in a preset way by inputting the high level from the terminal SC2 in a case that the driving circuit operates normally. S1 and S3 are switched off by changing the control signal input from the terminal SC2 from the high level to the low level in a case that the motor must be stopped because an exception occurs (for example, locked rotor in the motor). In this case, the TRIAC 26, the rectifier 28 and the position sensor 20 are switched off to ensure the whole circuit to be in a zero-power state. Meanwhile, it is avoided that the voltage dropper is overheated due to still continuous power supply in case of the exception.

It should be understood that the unidirectional thyristors S1 and S3 may be replaced by controllable semiconductor switches of other types.

FIG. 9A shows a circuit of the motor shown in FIG. 2 according to another embodiment. Different from the embodiment shown in FIG. 9, in FIG. 9A, the rectifier includes two optical couplers, one rectifying branch of the rectifier includes diodes D2 and D4 reversely connected in series, and the other rectifying branch includes two photosensitive semiconductor switches S1 and S3 reversely connected in series, one optical coupler is composed of each of the photosensitive semiconductor switches S1/S3 and a light emitter D1/D3, and two light emitters D1 and D3 of the two optical couplers are connected in parallel between two terminals SC1 and SC2. When a current flows between the terminals SC1 and SC2 to energize the light emitters D1 and D3 to emit light, the photosensitive semiconductor switches S1 and S3 receive light to generate a current. Based on the configuration, the two switches S1 and S3 may be switched between a switch-on state and a switch-off state in a preset way by flowing currents through the terminals SC1 and SC2 in a preset way in a case that the driving circuit operates normally. S1 and S3 are switched off by flowing no current through the terminals SC1 and SC2 in a case that the motor must be stopped because an exception occurs (for example, locked rotor in the motor). It is avoided that the voltage dropper is overheated due to still continuous power supply in case of the exception. In the embodiment, the photosensitive semiconductor switches S1 and S3 are photosensitive unidirectional thyristors. It should be understood that photosensitive semiconductor switches of other types may also be used in other embodiments.

FIG. 9B shows a circuit of the motor shown in FIG. 2 according to yet another embodiment. Different from the embodiment shown in FIG. 9A, in FIG. 9B, the rectifier includes two optical couplers, one rectifying branch of the rectifier includes diodes D2 and D4 reversely connected in series, and the other rectifying branch includes two unidirectional thyristors S1 and S3 reversely connected in series. Control terminals of the two unidirectional thyristors S1 and S3 are respectively connected to current output terminals of two photosensitive semiconductor switches O1 and O3 of the two optical couplers, one optical coupler is composed of each of the photosensitive semiconductor switches O1/O3 and a light emitter D1/D3, and two light emitters D1 and D3 of the two optical couplers are connected in parallel between two terminals SC1 and SC2. When a current flows between the terminals SC1 and SC2 to energize the light emitters D1 and D3 to emit light, the photosensitive semiconductor switches O1 and O3 receive light to generate a current to drive the switches S1 and S3 to be switched on. Based on the configuration, the two switches S1 and S3 may be switched between a switch-on state and a switch-off state in a preset way by flowing currents through the terminals SC1 and SC2 in a preset way in a case that the driving circuit operates normally. Filters are respectively connected in parallel between two terminals of each of the switches S1 and S3 to absorb a surge current, thereby avoiding that the switches S1 and S3 are switched on by mistake in case of no triggering signal. Preferably, the filters include resistors and capacitors connected in series between the two terminals of switches S1/S3. S1 and S3 are switched off by flowing no current between the terminals SC1 and SC2 in a case that the motor must be stopped because an exception occurs (for example, locked rotor in the motor), thereby avoiding that the voltage dropper is overheated due to still continuous power supply in case of the exception. In the embodiment, the photosensitive semiconductor switches O1 and O3 are photosensitive unidirectional thyristors. It should be understood that photosensitive semiconductor switches of other types may also be used in other embodiments. The switches S1 and S3 are unidirectional thyristors, and it should be understood that controllable semiconductor switches of other types may also be used in other embodiments. In this embodiment, a larger driving current may be provided by the optical coupler, the rectifier is allowed to use switches S1 and S3 supporting a larger current. Thus, a larger driving current is supplied to the control terminal of the bidirectional AC switch, and a bidirectional AC switch with a larger current rating may be used.

FIG. 10 shows a schematic circuit diagram of a single-phase permanent magnetic synchronous motor 10 according to an embodiment of the present disclosure. The stator winding 16 of the motor is connected in series with the integrated circuit 18 between two terminals of the AC power supply 24. A driving circuit for the motor is integrated into the integrated circuit 18, and the driving circuit enables the motor to start in a fixed direction every time the motor is powered on. In the present disclosure, the driving circuit for the motor is packaged in the integrated circuit, and thus the cost of the circuit can be reduced and the reliability of the circuit can be improved.

In the present disclosure, based on actual situations, all or a part of the rectifier, the detecting circuit, the switch control circuit, the controllable bidirectional AC switch may be integrated into the integrated circuit. For example, as shown in FIG. 3, only the detecting circuit, the switch control circuit and the controllable bidirectional AC switch are integrated into the integrated circuit, and the rectifier is disposed outside the integrated circuit.

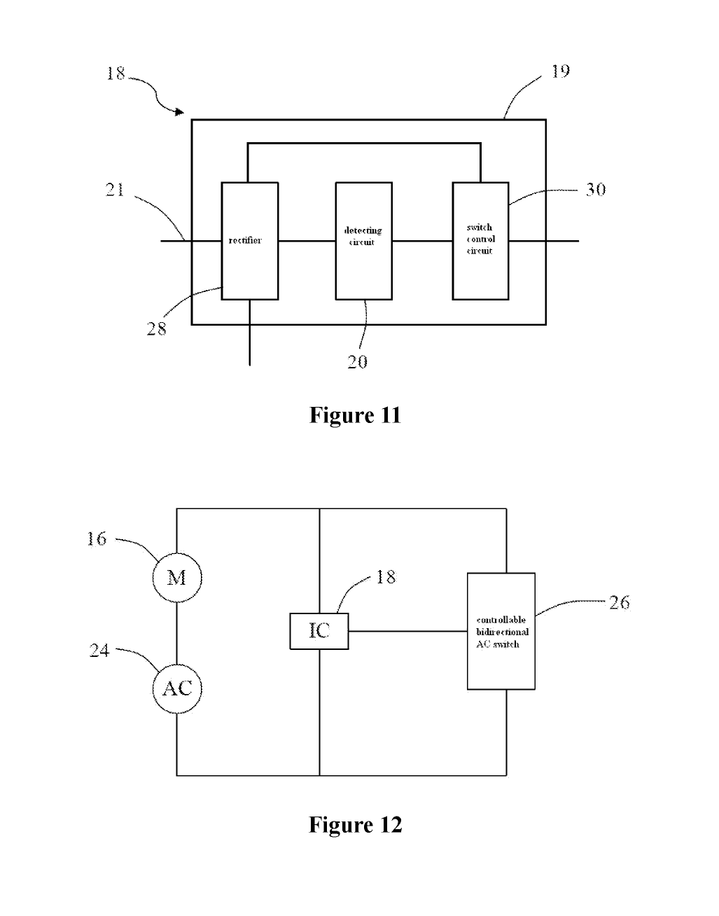

For example, as shown in the embodiments of FIG. 10 and FIG. 11, the voltage dropping circuit 32 and the controllable bidirectional AC switch 26 are disposed outside the integrated circuit, and the rectifier (which may only include the rectifier bridge but not include a voltage dropping resistor or other voltage dropping assemblies), the detecting circuit and the switch control circuit are integrated into the integrated circuit. In the embodiment, a low power part is integrated into the integrated circuit, and the voltage dropping circuit 32 and the controllable bidirectional AC switch 26 as high power parts are disposed outside the integrated circuit. In an embodiment as shown in FIG. 12, the voltage dropping circuit 32 may be integrated into the integrated circuit, and the controllable bidirectional AC switch is disposed outside the integrated circuit. In a case that rectifier as shown in FIG. 9, 9A and 9B is integrated into the integrated circuit, the integrated circuit is preferably provided with external pins respectively connected to the first signal terminal and the second signal terminal. Hence, the control signal is inputted from the integrated circuit to control the two semiconductor switches S1 and S3.

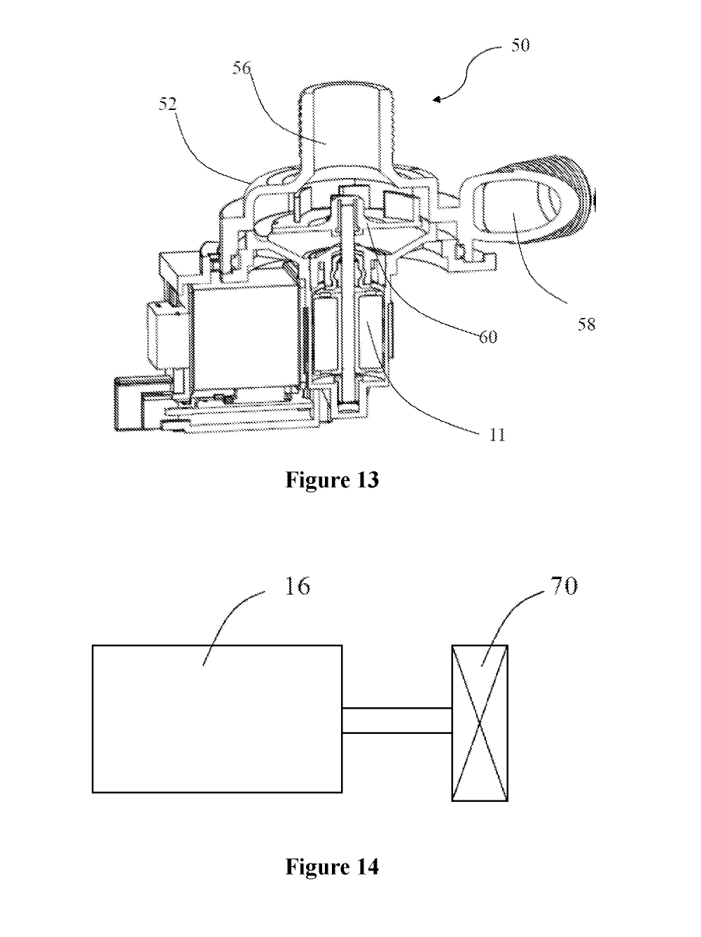

FIG. 13 shows a water pump 50 using the motor described above. The water pump 50 includes a pump housing 54 having a pump chamber 52, an entrance 56 and an exit 58 in communication with the pump chamber, an impeller 60 rotatably disposed in the pump chamber, and a motor assembly configured to drive the impeller. FIG. 14 shows a fan using the motor described above. The fan includes a flabellum 70 driven directly or indirectly via an output axis of the motor.

With the single-phase permanent magnetic synchronous motor according to embodiments of the present disclosure, the single-phase permanent magnetic synchronous motor is ensured to start and rotate in a fixed direction every time the single-phase permanent magnetic synchronous motor is powered on. In applications of the fan such as an exhaust fan and a range hood, and the water pump such as a circulating pump and a wet-pit pump, a flabellum and an impeller driven by the rotor may have curved vanes, and thus the efficiency of the fan and the water pump is improved.

In a motor assembly according to another embodiment, a motor may be connected in series with a bidirectional AC switch between a node A and a node B, and the node A and the node B may be connected to the two terminals of the AC power supply respectively.

The motor assembly according to the embodiments of the disclosure may be applied to, but not limited to, a pump, a fan, a household appliance or a vehicle, and the household appliance may include such as a washing machine, a dishwasher, a range hood, a vent fan.

What is described above is only preferred embodiments of the present disclosure and is not intended to define the scope of protection of the present disclosure. Any changes, equivalent substitution, improvements and so on made within the spirit and principles of the present disclosure are all contained in the scope of protection of the present disclosure. For example, the driving circuit according to the present disclosure not only is applied to the single-phase permanent magnetic synchronous motor, but also is applied to other types of permanent magnetic motors such as a single-phase brushless DC motor.

1. A driving circuit for a motor, comprising:
a bidirectional AC switch connected in series with the motor between two terminals of an external AC power supply;
a switch control circuit connected to a control terminal of the bidirectional AC switch; and
a detecting circuit configured to detect a magnetic field of a rotor of the motor and output a detection signal to the control terminal of the switch control circuit,
wherein at least two or all of the bidirectional AC switch, the switch control circuit and the detecting circuit are integrated into single integrated circuit.

2. The driving circuit according to claim 1, further comprising: a rectifier having a controllable semiconductor switch.

3. The driving circuit according to claim 2, wherein the controllable semiconductor switch is a unidirectional thyristor or a photosensitive semiconductor switch.

4. The driving circuit according to claim 2, wherein the rectifier comprises two rectifying branches connected in parallel, and one of the two rectifying branches comprises a pair of controllable semiconductor switches reversely connected in series.

5. The driving circuit according to claim 4, wherein the pair of controllable semiconductor switches is a pair of photosensitive semiconductor switches, the driving circuit further comprises a pair of light emitters respectively coupled with the pair of photosensitive semiconductor switches, and the driving circuit further comprises a first signal terminal and a second signal terminal, the pair of light emitters being connected in parallel between the first signal terminal and the second signal terminal.

6. The driving circuit according to claim 4, wherein the driving circuit further comprises a first signal terminal and a second signal terminal, a pair of optical couplers connected in parallel between the first signal terminal and the second signal terminal, and the pair of controllable semiconductor switches is controlled by the pair of the optical coupler respectively.

7. The driving circuit according to claim 4, wherein the pair of controllable semiconductor switches is a pair of unidirectional thyristors, and the driving circuit further comprises a first signal terminal connected to cathodes of the pair of unidirectional thyristors and a second signal terminal connected to control terminals of the pair of unidirectional thyristors.

8. The driving circuit according to claim 2, further comprising: a voltage dropper connected in series with the rectifier, wherein the rectifier controls the voltage dropper to be powered off when the motor is out of order.

9. The driving circuit according to claim 2, wherein the rectifier is integrated into the integrated circuit, and the integrated circuit comprises external pins for controlling the controllable semiconductor switch.

10. The driving circuit according to claim 2, wherein the rectifier is integrated into the integrated circuit; and the integrated circuit comprises external pins connected to the first signal terminal and the second signal terminal respectively.

11. The driving circuit according to claim 1, wherein the switch control circuit is configured to control the bidirectional AC switch to switch between a switch-on state and a switch-off state in a preset way responsive to the detection signal and a polarity of the AC power supply.

12. The driving circuit according to claim 1, wherein the switch control circuit comprises: a first switch coupled in a first current path, and the first current path arranged between the control terminal of the bidirectional AC switch and a high voltage; and
a second switch coupled in a second current path, and the second current path arranged between the control terminal of the bidirectional AC switch and a low voltage.

13. The driving circuit according to claim 1, wherein the switch control circuit comprises a first current path allowing a current flow out from the control terminal of the bidirectional AC switch, a second current path allowing a current flow into the control terminal of the bidirectional AC switch, and a switch connected in one of the first current path and the second current path, and the switch is controlled by the detection signal to selectively switch on the first current path and the second current.

14. The driving circuit according to claim 1, wherein the controllable bidirectional AC switch is turned on under control of the switch control circuit in a case that the AC power supply is in a positive half cycle and the magnetic field polarity of the rotor is a first polarity, or in a case that the AC power supply is in a negative half cycle and the magnetic field polarity of the rotor is a second polarity opposite to the first polarity.

15. A motor assembly, comprising: a motor and the driving circuit for the motor according to claim 1.

16. The motor assembly according to claim 15, wherein the motor comprises a stator and a rotor, the stator comprises a stator core and a single-phase winding wound on the stator core.

17. The motor assembly according to claim 15, wherein the motor is a permanent magnet brushless motor.

18. An integrated circuit, comprising: a housing, a semiconductor substrate arranged in the housing, several pins extended out from the housing, and an electronic circuitry having a rectifier arranged on the semiconductor substrate, wherein the rectifier comprises a controllable switch.

19. The integrated circuit according to claim 18, wherein the controllable switch is a unidirectional thyristor or a photosensitive semiconductor switch.

20. The integrated circuit according to claim 18, wherein the electronic circuitry comprises a part or all of a bidirectional AC switch, a switch control circuit and a detecting circuit.
